(19) United States
(12) Patent Application Publication
(10) Pub. No.: US 2006/0264288 A1
(43) Pub. Date: Nov. 23, 2006

(54) Composite chain and associated methods of use and manufacture

(76) Inventors: Michael A. Allen, Santa Cruz, CA (US); Erik Yip, Oakland, CA (US); Dirk V. Wodtke, Soquel, CA (US); Bertold Hawener, Ensdorf (DE)

Correspondence Address: PERKINS COIE LLP;PATENT-SEA, P.O. BOX 1247, SEATTLE, WA, 98111-1247, US

(21) Appl. No.: 11/388,239

(22) Filed: Mar. 23, 2006

Related U.S. Application Data
(60) Provisional application No. 60/665,332, filed on Mar. 24, 2005.

(51) Int. Cl. F16G 13/02

(52) U.S. Cl. 474/207

(57) ABSTRACT

Composite chains and associated methods are disclosed. A chain in accordance with one embodiment of the invention includes an arrangement of outer plates, and inner plates joined by connecting pins. Spacers can also be provided between the inner plates as separate components or as part of the connecting pins. The chain can be used for bicycles and/or other machinery. At least one of the components of the chain (e.g., the outside plates, the inside plates, the spacers, and/or the connecting pins) can include a composite material (e.g., a carbon fiber composite material).

### CROSS-REFERENCE TO RELATED APPLICATION

The present application claims priority to U.S. Provisional Application No. 60/665,332, filed Mar. 24, 2005 and incorporated herein in its entirety by reference.

### TECHNICAL FIELD

The present invention relates generally to composite chains (e.g., carbon fiber composite chains) and associated methods of use and manufacture.

### BACKGROUND

Conventional linked metal chains have been used for bicycles and other machines for many years. Examples of such chains are disclosed in the following U.S. patents: No. 586,472 to Appleby; No. 600,595 to Pond; and No. 3,054,300 to Bowman. One feature typically associated with such chains is that they use a lubricant (e.g., an oil) to keep the components of the chain operating smoothly. One drawback with the lubricant is that it can break down and/or be flung from the chain, and accordingly must be replaced at periodic intervals. Another drawback with the lubricant is that it is typically viscous and can accordingly attract particulates, abrasives, and/or other contaminants that can reduce the life of the chain.

### BRIEF DESCRIPTION OF THE DRAWINGS

FIG. 1A is a partially schematic isometric illustration of a chain configured in accordance with an embodiment of the invention.

FIG. 1B is a partially schematic side elevation view of components of the chain shown in FIG. 1A, configured in accordance with an embodiment of the invention.

FIG. 1C is a partially schematic top view of the chain components shown in FIG. 1B.

FIG. 1D is a partially schematic top exploded view of components of the chain positioned for assembly in accordance with an embodiment to the invention.

FIG. 2 is a partially schematic top exploded view of components of a chain positioned for assembly in accordance with another embodiment of the invention.

FIG. 3 is a partially schematic illustration of a bicycle on which a chain is installed in accordance with an embodiment of the invention.

### DETAILED DESCRIPTION

The following disclosure describes embodiments of chains and corresponding methods for manufacturing and using chains. A chain in accordance with a particular aspect has a plurality of components, including multiple pairs of spaced apart outside plates and multiple pairs of spaced apart inside plates positioned between corresponding pairs of outside plates. Connecting pins can extend through the inside plates and can be connected to the outside plates, with at least one of the components being formed from a composite material. For example, the outside plates, the inside plates, and the connecting pins can all be formed from a composite material having an at least generally similar composition. In other embodiments, the connecting pin can be formed from a metallic material.

In still a further embodiment, spacers having spacer apertures can be positioned at opposing ends of the inside plates and between opposing outside plates, with each connecting pin extending through an aperture of a corresponding one of the spacers. In another arrangement, the spacer can be eliminated and instead, the connecting pin can have a connecting portion and a spacer portion that is fixed relative to the connecting portion. The connecting portion can have a first diameter and can be connected to a corresponding pair of outside plates, while the spacer portion can have a second diameter greater than the first diameter and can be positioned to restrict motion of the inside plates toward each other.

Other aspects are directed to methods for making a chain. One such method can include providing chain components, including inside plates, outside plates, and connecting pins, wherein at least one of the components is formed from a composite material. The components can be assembled by placing multiple pairs of spaced apart inside plates between corresponding pairs of spaced apart outside plates, passing connecting pins through the inside plates, and attaching the connecting pins to the outside plates. The composite components can be formed using a molding process, a stamping process, or another suitable process.

In particular embodiments, at least one composite component can include a matrix material having a first composition and a distribution of elements in the matrix material, with the elements having a second composition different than the first. In still further particular embodiments, the method can include selecting the matrix material to have a color that is distributed throughout the matrix material. For example, the matrix material can include a fluorescent or reflective material. A coloring agent can be added to the matrix material to provide the color, without having an effect on the material properties of the matrix material. In still further particular embodiments, the selected color of the matrix material can be correlated with a physical characteristic of the chain, for example, the length of the chain.

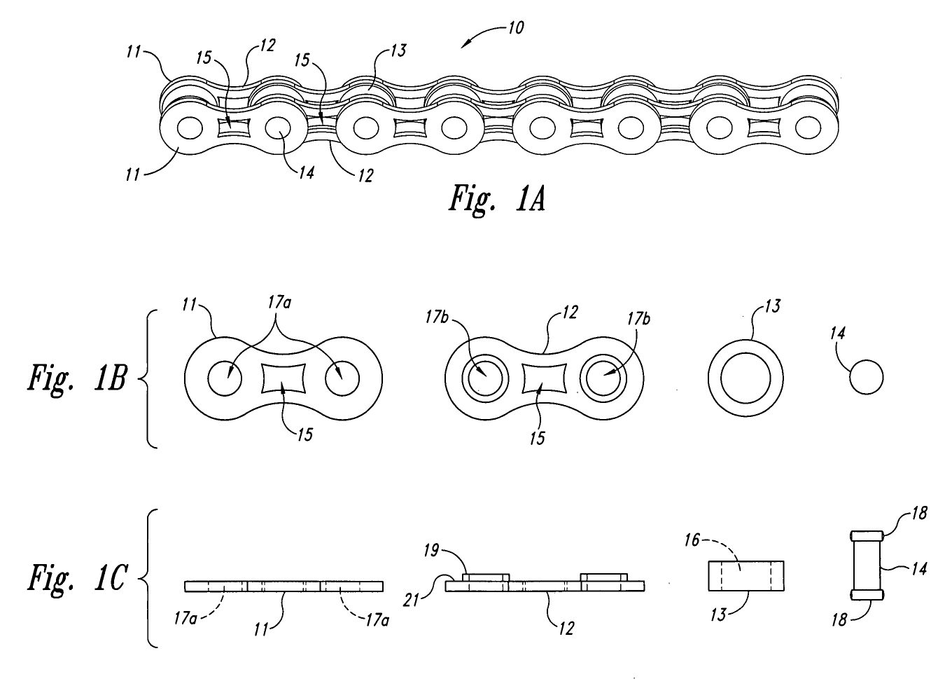

Several details of the disclosed structures and methods that are well known and often associated with these devices and methods are not set forth in the following description for purposes of brevity. Moreover, although the following disclosure sets forth several embodiments of different aspects of the invention, several other embodiments of the invention can have different configurations and/or components than those described below. Accordingly, the invention may have other embodiments with additional elements and/or without several of the elements described below with reference to FIGS. 1A-3.

FIG. 1A is an isometric illustration of a portion of a chain 10 that includes composite components in accordance with a particular embodiment of the invention. The chain can include a plurality of outside plates 11 that are arranged in pairs. Pairs of inside plates 12 are positioned to extend between the outside plates 11, and are joined to the outside plates 11 with connecting pins 14. The connecting pins 14 can pass through spacers 13 that are positioned between opposing inside plates 12 to maintain the relative positions of the inside plates 12.

FIG. 1B illustrates a side elevation view of the components described above with reference to FIG. 1A, and FIG. 1C illustrates a top view of these components. Referring to FIGS. 1A-1C, some or all of the components forming the chain 10 can be made from a composite material. As used herein, the term “composite material” refers generally to a combination of materials that (a) have different properties and (b) tend not to blend or dissolve into each other when mixed. For example, composite materials can include a matrix material that carries fibers or other elements that are dispersed throughout the matrix material. In particular embodiments, the composite material can include a polymer having carbon fibers distributed throughout. In other embodiments, the matrix material and/or the fibers (or other elements) can have compositions other than those described above. In still further embodiments, the composite material can include additional constituents. For example, the composite material can include embedded lubricants and/or other materials that tend to reduce friction between adjacent composite components. For example, the composite material can be impregnated with Teflon®. In particular embodiments, the composite material includes no metallic constituents. As will be described in greater detail later, reducing the amount of metal in the chain can reduce the likelihood for the chain to rust or otherwise corrode.

The components of the chain 10 can be formed with any of a variety of existing processes suitable for manufacturing composite parts. For example, the outside plates 11 and inside plates 12 can be cut out from flat composite stock using existing processes, including stamping processes. The connecting pin 14 can be made from a solid composite material, or it can be made from a rolled-up portion of composite sheet stock. The spacer 13 can also be made from a rolled-up portion of composite sheet stock, or can be made from a solid composite with a hole 16 drilled through the spacer 13. Pin holes 17a, 17b can also be formed in the outside plate 11 and the inside plate 12 to receive the connecting pins 14. Axisymmetric components, such as the pins 14 and the spacers 13 can be turned on a lathe or formed via another suitable machining operation. In other embodiments, the foregoing components can be manufactured using other techniques, e.g., molding techniques. Suitable materials and processes for forming the materials into the components illustrated in FIGS. 1A-1C are available from manufacturers including DragonPlate of Auburn, N.Y.

In a particular aspect of an embodiment shown in FIGS. 1A-1C, the outside plates 11 and/or the inside plates 12 can include lightening holes 15. The lightening holes 15 can reduce the weight of these components and can accordingly reduce the weight of the chain 10. In other embodiments, not every outside plate 11 or every inside plate 12 includes a lightening hole 15, and instead, only selected outside plates 11 and/or selected inside plates 12 can include such holes.

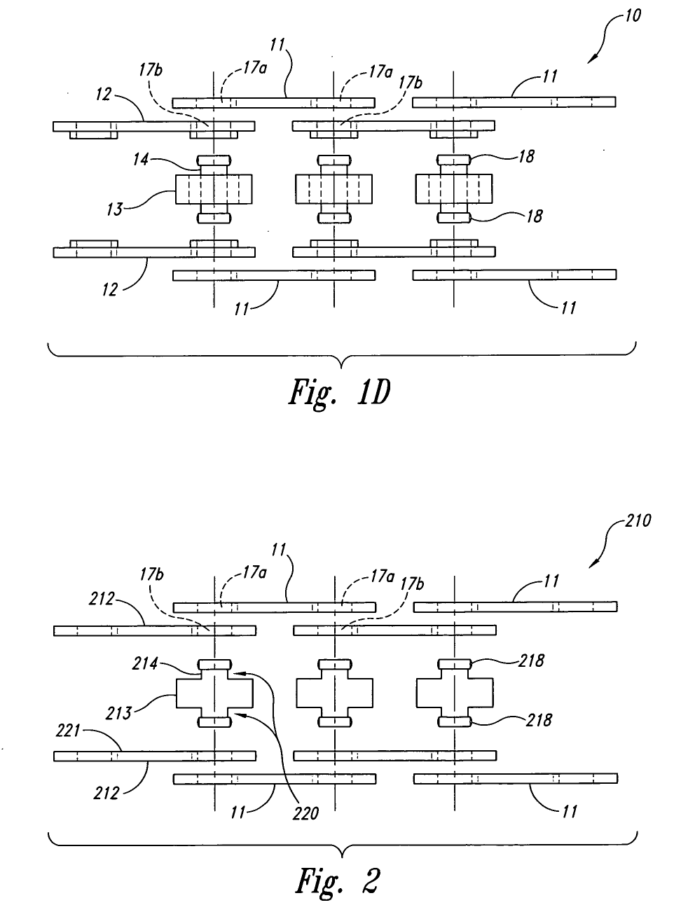

Each of the inside plates 12 can have an inwardly facing surface 21, and risers 19 that project inwardly from the inwardly facing surface 21. The risers 19 can fit inside the corresponding hole 16 of the spacer 13 for positioning the spacer 13. In other embodiments, the risers 19 can be eliminated, for example, as discussed later with reference to FIG. 2.

The pins 14 can be elongated and can include a lip 18 at each end. The lip 18 can have a slightly greater diameter than the rest of the pin 14, and can have a slightly greater diameter than the corresponding pin hole 17a in the outside plate 11. Accordingly, the pin 14 can be pressed against the pin hole 17a until the lip 18 passes through the pin hole 17a to secure the pin 14 to the outside plate 11. In one embodiment, the pin 14 can be formed from a composite material (e.g., the same composite material as is used for the outside plates 11 and the inside plates 12), and in other embodiments, the pin 14 can be formed from a metal or metal alloy.

FIG. 1D illustrates a process for assembling the chain 10 from the components described above with reference to FIGS. 1A-1C. The process can include positioning pairs of inside plates 12 in a spaced apart fashion, and positioning pairs of outside plates 11 in a staggered fashion relative to the inside plates 12, with pin holes 17a of the outside plates 11 aligned with corresponding pin holes 17b of the inside plates 12. Spacers 13 can be aligned between each set of aligned pin holes 17a, 17b, and a connecting pin 14 can be inserted through the spacer 13 and the pin holes 17a, 17b. The pin holes 17b in the inside plates 12 can be oversized so as to allow relative rotational movement between the connecting pin 14 and the inside plates 12. The pin holes 17a in the outside plates 11 can be smaller so that the connecting pins 14 are press fit into the pin holes 17a of the outside plates 11, thereby securing the links of the chain 10 together. In particular embodiments, the ends of the pins 14 can be swaged, formed, heated and/or otherwise treated to secure the pins 14 to the outside plates 11. In other embodiments, the lip 18 alone can be sufficient to prevent the pins 14 from disengaging with the outside plates 11.

Several features of embodiments of the chains described above are expected to provide advantages over conventional metallic chains. For example, it is expected that embodiments of the chain will not require oiling. In some embodiments, eliminating the need for oiling may be due to lubricants that are embedded in the materials forming the components of the chain. In other embodiments, it is expected that the inherent lubricating characteristics of the composite materials may be sufficient to allow the chain to operate efficiently with a relatively low level of friction. By eliminating the lubricant, the chain can be kept cleaner than can conventional chains, and can eliminate the likelihood for lubricants to stick to a user's skin and/or clothing during use.

Another feature of at least some embodiments of the chains described above is that they can include lightening holes in at least some of the components. The lightening holes can reduce the overall weight of the chain, which can also be reduced (relative to conventional chains) by virtue of the relatively light weight of the composite material, relative to conventional metallic materials. Accordingly, the chain can be more efficient to use in particular applications, for example, when the chain is used as a bicycle chain. It is expected that in at least some embodiments, a chain formed from a carbon fiber composite material can weigh from about 65% to about 75% of a corresponding chain made from conventional metallic components (e.g., steel).

Another feature of an embodiment of the chain that includes composite parts is that the parts are not expected to be susceptible to rusting. Accordingly, the chain is less likely to wear out during normal use and as a result need not be replaced as frequently as chains made from conventional metallic materials. It is expected that the foregoing features can be provided in the chain without compromising the strength of the chain. Accordingly, it is expected that a chain having composite components may be used in most if not all installations in which metallic chains are currently being used. Such installations include bicycles, machinery, and many other commercial, industrial and household applications.

Another feature of an embodiment of the chains described above is that the connecting pins are expected to form a tight connection with the pin holes in the outer plates, and are not expected to stretch the pin holes in the inside plates during use. Because the connecting pins are not expected to enlarge the pin holes in the inside plates (or at least enlarge these holes by an amount less than would be expected with conventional metallic materials), the length of the chain is expected not to increase significantly during use. As a result, it is expected that the chain itself and/or the bicycle or other machine on which the chain is installed will need to be adjusted on a less frequent basis because the components of the chain tend to maintain their manufactured shapes for a longer period of time.

Still another feature of embodiments of the chain described above is that the materials forming the composite components can be manufactured in a variety of colors. Accordingly, chain manufacturers can select a color for the chain which may appeal to the users aesthetic sensibilities and/or which may provide utilitarian functions. Such utilitarian functions can include chains having lengths and/or other characteristics that are color coded. For example, a chain having one length can have one color selected from an array of available colors, and a chain having a different length can have another color selected from the array. This arrangement can make it easier to readily identify and distinguish between chains having different physical characteristics. Representative physical characteristics (in addition to chain length) can include chain strength, width, weight, expected performance characteristics, and/or other characteristics.

In still further embodiments, the color of the chain can serve other utilitarian functions. For example, the chain can be fluorescent and/or reflective to increase visibility. This arrangement may be particularly advantageous for bicycle chains because increased visibility can improve the level of safety for the rider.

In any of the foregoing embodiments, the color of the chain component(s) can be distributed generally throughout the volume of the component(s). For example, if the outer plates 11 have a composite composition, the matrix material itself can have a selected color distributed throughout the matrix material. The selected color can be added to the matrix material by adding a selected dye to the matrix material as the material is constituted, without having any effect on the material properties or physical characteristics (e.g., the strength) of the matrix material. This arrangement is unlike adding paint or a similar coating to the outside surface of the component. It is expected that this arrangement will result in the selected color of the component lasting significantly longer then if the component were merely coating with a colored paint.

As discussed above, the matrix material can be selected to have a particular color. In other embodiments, the fibers or other elements distributed in the matrix material can also have a selected color. The color of the distributed elements can be the same as or different than the color of the matrix material.

FIG. 2 illustrates components of a chain 210 configured in accordance with another embodiment of the invention. The chain 210 can include outside plates 11 that are generally similar to those described above with reference to FIGS. 1A-1C. The separate pin 14 and spacer 13 described above with reference to FIGS. 1A-1C can be replaced by a pin 214 that includes a connecting portion 220 and a spacer portion 213. The connecting portion 220 can project on either side of the spacer portion 213, and can include a lip 218 that passes through the pin hole 17a of the corresponding outside plate 11. The spacer portion 213 can have an overall shape envelope generally similar to that of the spacer 13 shown in FIGS. 1A-1C, but can be fixed relative to the connecting portion 220. Accordingly, the connecting portion 220 and the spacer portion 213 can have unitary construction and can be formed from a single volume of composite material, for example, using a turning process. The connecting portion 220 can have a diameter that is less than that of the spacer portion 213 so as to pass through the pin hole 17b of the corresponding inside plate 212 and the pin hole 17a of the outside plate 11. The spacer portion 213 can have a diameter large enough to prevent or at least restrict relative motion of the inside plates 212 toward and away from each other. The inside plates 212 can have a generally uniformly flat, inwardly facing surface 221, without the risers 19 shown in FIG. 1C. In a particular aspect of this embodiment, the risers can be eliminated, because the spacer portions 213 are fixed relative to the connecting portions 220 and do not include the spacer holes 16 shown in FIG. 1C.

One expected benefit of integrating the spacer and the pin into a pin that includes a connecting portion and a spacer portion is that it can reduce the number of components of the resulting chain 210. Accordingly, the chain 210 can be simpler and/or less expensive to produce, and may have a longer expected life time.

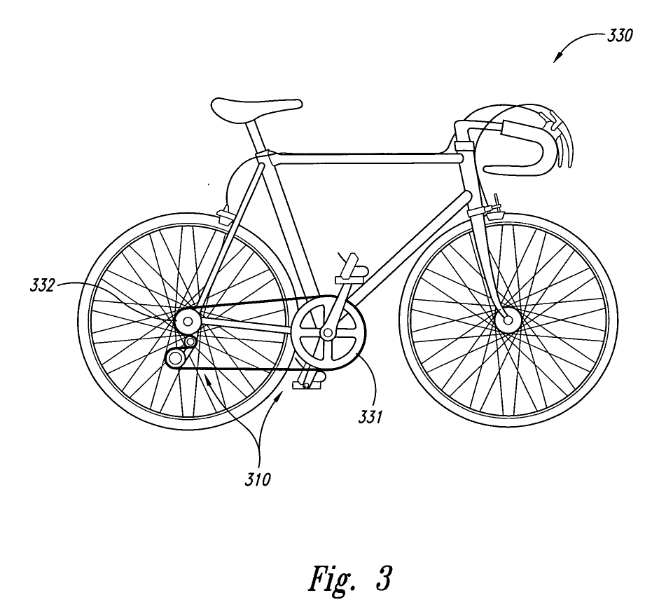

Chains having configurations in accordance with any of the embodiments described above may be installed in a wide variety of devices. FIG. 3 illustrates one such device, a bicycle 330. The bicycle 330 can include a first or forward sprocket 331, a second or rear sprocket 332, and a chain 310 engaged with both the first sprocket 331 and the second sprocket 332. Accordingly, the pins of the chain 310 are spaced apart by a distance corresponding to the pitch of the sprocket teeth. The chain 310 can have any of the characteristics described above with reference to FIGS. 1A-2. The bicycle 330 need not include any particular adaptations in order to accommodate the chain 310. Accordingly, the composite chain 310 can readily replace a conventional metal chain.

From the foregoing, it will be appreciated that specific embodiments of the invention have been described herein for purposes of illustration, but that various modifications may be made without deviating from the invention. For example, in some embodiments, not all of the components forming the chain need be made from composites. Selected components can be made from metals (e.g., steel or titanium) and/or other materials, with the selection of such components and materials based upon the particular use to which the chain is expected to be put. In a particular embodiment, all the composite components of the chain can have at least generally the same composition, for example, so that all the composite components have at least approximately the same coefficient of thermal expansion. In other embodiments, different composite components can have different compositions. In some embodiments, the lightening holes can be eliminated, for example, if the chain strength requirements are such that the lightening holes unacceptably compromise the chain strength. Aspects of the invention described in the context of particular embodiments may be combined or eliminated in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited except as by the appended claims.

I/we claim:

1. A chain, comprising:
a plurality of components, including:
multiple pairs of spaced apart outside plates;
multiple pairs of spaced apart inside plates positioned between corresponding pairs of outside plates; and
connecting pins extending through the inside plates and connected to the outside plates, wherein at least one of the components is formed from a composite material.

2. The chain of claim 1 wherein the outside plates, the inside plates and the connecting pins are formed from a composite material having an at least generally similar composition for each component.

3. The chain of claim 1, further comprising spacers having spacer apertures and being positioned at opposing ends of the inside plates and between opposing outside plates, wherein each connecting pin extends through a spacer aperture of a corresponding spacer.

4. The chain of claim 3 wherein at least one of the spacers is formed from a composite material.

5. The chain of claim 1 wherein each of the connecting pins has a connecting portion with a first diameter and a spacer portion that is fixed relative to the connecting portion and has a second diameter greater than the first diameter, and wherein the connecting portion is connected to a corresponding pair of outside plates, and wherein the spacer portion is positioned between corresponding inside plates to restrict motion of the inside plates toward each other.

6. The chain of claim 1 wherein the inside plates have generally uniformly flat inwardly facing surfaces.

7. The chain of claim 1, wherein the outside plates include pin holes positioned to receive the connecting pins, and wherein the outside plates further include lightening holes located between the pin holes.

8. The chain of claim 1 wherein the outside plates, inside plates and connecting pins are configured for use with a bicycle.

9. The chain of claim 1 wherein the connecting pins include a rolled sheet of composite material.

10. The chain of claim 1 wherein the connecting pins include at least one of a metal and a metal alloy.

11. The chain of claim 1 wherein the composite material includes an embedded lubricant.

12. The chain of claim 1 wherein the composite material does not include a metal material.

13. The chain of claim 1 wherein the composite material includes a matrix material having a first composition and a distribution of elements in the matrix material, the elements having a second composition different than the first.

14. The chain of claim 13 wherein the matrix material includes a polymer and wherein the elements include carbon fibers.

15. The chain of claim 13 wherein the matrix material has a selected color that is distributed generally uniformly throughout the matrix material.

16. The chain of claim 15 wherein the color is associated with a length of the chain.

17. The chain of claim 13 wherein the matrix material includes a fluorescent material that is distributed generally uniformly throughout the matrix material.

18. The chain of claim 13 wherein the matrix material includes a reflective material that is distributed generally uniformly throughout the matrix material.

19. A bicycle system, comprising:
a bicycle chain that includes:
multiple pairs of spaced apart outside plates, the outside plates being formed from a composite material that includes a matrix material having a first composition and a generally uniform distribution of fibers in the matrix material, the fibers having a second composition different than the first composition, the outside plates having first pin holes with first pin hole diameters;
multiple pairs of spaced apart inside plates positioned between corresponding pairs of outside plates and formed from the composite material, the inside plates having second pin holes with second pin hole diameters that are larger than the first pin hole diameters; and
connecting pins extending through the inside plates and connected to the outside plates, the connecting pins having outside diameters that are smaller than the second pin hole diameters, the connecting pins including the composite material, the connecting pins being spaced apart by a pitch corresponding to a bicycle sprocket pitch.

20. The system of claim 19 wherein the multiple pairs of spaced apart outside plates, multiple pairs of spaced apart inside plates, and connecting pins are connected to form a first bicycle chain having a first physical characteristic, and wherein the matrix material has a first color distributed generally uniformly throughout, the first color being associated with the first physical characteristic and being selected from a plurality of available colors, and wherein the system further comprises a second bicycle chain having a second physical characteristic different than the first physical characteristic, the second bicycle chain including at least one component formed from the composite material, wherein the matrix material of the at least one component has a second color distributed generally uniformly throughout, the second color being associated with the second physical characteristic and being selected from the plurality of available colors, the second color being different than the first color.

21. The system of claim 20 wherein the first physical characteristic includes a first chain length and the second physical characteristic includes a second chain length different than the first chain length.

22. The system of claim 19, further comprising a bicycle having multiple sprockets, and wherein the chain is engaged with the sprockets of the bicycle.

23. A method for making a chain, comprising:
providing chain components, including inside plates, outside plates and connecting pins, wherein at least one of the components is formed from a composite material; and
assembling the components of the chain by:
placing multiple pairs of spaced apart inside plates between corresponding pairs of spaced apart outside plates;
passing connecting pins through the inside plates; and
attaching the connecting pins to the outside plates.

24. The method of claim 23, further comprising forming the at least one component using a molding process.

25. The method of claim 23, further comprising forming the at least one component using a stamping process.

26. The method of claim 23, further comprising forming the at least one component to include a matrix material having a first composition and a distribution of elements in the matrix material, the elements having a second composition different than the first.

27. The method of claim 26, further comprising:
selecting the matrix material to include a polymer; and
selecting the elements to include carbon fibers.

28. The method of claim 26, further comprising selecting the matrix material to have color that is distributed throughout the matrix material.

29. The method of claim 26, further comprising selecting the matrix material to include a fluorescent material that is distributed throughout the matrix material.

30. The method of claim 26, further comprising selecting the matrix material to include a reflective material that is distributed throughout the matrix material.

31. The method of claim 26, further comprising adding a coloring agent to the matrix material, wherein the addition of the coloring agent has generally no effect on material properties of the matrix material.

32. The method of claim 23, further comprising selecting a color of the matrix material from a plurality of available colors to be correlated with a physical characteristic of the chain.

33. The method of claim 32, further comprising selecting the color to be associated with a length of the chain.

34. The method of claim 23, further comprising embedding a lubricant in the composite material.

35. The method of claim 23, further comprising selecting the composite material to be devoid of metal.

36. The method of claim 23, further comprising deforming the pins to at least restrict the pins from disengaging from the outside plates.

37. The method of claim 23, further comprising installing the chain on a bicycle.

38. The method of claim 23, further comprising positioning spacers at opposing ends of the inside plates and passing each connecting pin through an aperture of a corresponding spacer.

39. The method of claim 23, further comprising:
forming the outside plates to have pin holes positioned to receive the connecting pins; and
forming the outside plates to have lightening holes located between the pin holes.

40. The method of claim 23, further comprising selecting the pins to include at least one of a metal and a metal alloy.

41. The method of claim 23, further comprising positioning a spacer between each pair of inside plates, and passing the connecting pins through apertures of the spacers.

42. The method of claim 23 wherein the connecting pin has a connecting portion with a first diameter and a spacer portion that is fixed relative to the connecting portion and has a second diameter greater than the first diameter, and wherein the method further comprises attaching the connecting portion to a corresponding pair of outside plates, and positioning the spacer portion between corresponding inside plates to restrict motion of the inside plates toward each other.
